(19) United States
(12) Patent Application Publication
(10) Pub. No.: US 2014/0215829 A1
(43) Pub. Date: Aug. 7, 2014

(54) Safety nail clipper for pets

(71) Applicant: Karina S. Peschardt, Rockville, MD (US)

(72) Inventor: Karina S. Peschardt, Rockville, MD (US)

(21) Appl. No.: 14/171,547

(22) Filed: Feb. 3, 2014

Related U.S. Application Data
(60) Provisional application No. 61/760,255, filed on Feb. 4, 2013.

(51) Int. Cl. A01K 17/00; A01K 13/00

(52) U.S. Cl. CPC A01K 17/00; A01K 13/00
USPC 30/28; 30/26

(57) ABSTRACT

A safety nail clipper for safe and fast cutting of the nails of a pet or wild animal can include a nail clipper body, a cutting implement, and a funnel, such that the funnel can guide a pet nail to a cutting location. Alternatively, a safety nail clipper can include a top piece, a top blade, a bottom piece, a bottom blade, and a funnel, such that the funnel guides a pet nail to a cutting location, where the top and the bottom blades meet when the top and bottom pieces are pressed together. Additionally, a safety nail clipper with a funnel can further include a safety stop, which serves to stop the nail from entering too far past the cutting location, to avoid cutting into the quick of the nail.

### CROSS-REFERENCE TO RELATED APPLICATIONS

This application claims the benefit of U.S. Provisional Application No. 61/760,255, filed Feb. 4, 2013.

### FIELD OF THE INVENTION

The present invention relates generally to the field of nail cutting devices for cats, dogs, and other pets.

### BACKGROUND OF THE INVENTION

Dogs and many other pets need to have their nails cut. However, most pets dislike having their nails cut. They will often become scared and agitated, and may struggle and wriggle, making it very tricky to use the traditional scissor and guillotine-style nail clippers. With one slight movement, the clippers can accidentally cut into the quick of the nail, causing pain, bleeding, and risking infection.

Consequently, most pet owners dread nail-cutting time. They face a difficult choice of either leaving it to professionals, such as vets and groomers, which is costly and time consuming, or doing it at home and saving the money and time, but risking hurting their pet.

There are nail clippers that are advertised as safe. Some, such as the original Millers Forge clippers and others like them, have a so-called safety bar. Its purpose is to aid in cutting the pet's nails at a safe length without getting too close to the quick.

Others are of the Dremel type. Here, the safety feature is a rotating file that shaves away the tip of the pet's nail. One such device on the market is the Peticure, another is the original Dremel.

Then there is the Quickfinder range of nail clippers. The safety feature is a patented technology that senses the pet's quick and signals when it is safe to cut. Red light signals that the clipper is over the quick, yellow light that the clipper is near the quick, and green light that it is safe to cut.

But all types have limitations: The safety bar type necessitates the nail being led through to the very small area that is the safety bar. But a struggling and wriggling pet can make this difficult. Amid the furor, the nail easily ends up in the hollow area immediately next to the cutting hole. Here, incorrectly positioned, the nail will be cut in a skewed way that can cause injury. The fact that the nail clipper is advertised as safe increases this risk, because the owner operates in the mistaken belief that the clipper is foolproof safe, and so may cut too hastily and arbitrarily.

With the Dremel type, the risk of cutting the quick is eliminated, but injury can still ensue if the nail is filed too far. This battery-driven clipper is also quite expensive, and some pets do not react well to the vibration and noise. Yet their greatest problem is that they take a long time, as filing takes much longer than cutting. However, most dogs will not cooperate and stand still for the 10 minutes or more it takes to use the clipper.

With the Quickfinder type, the instruction is to move the clipper slowly up the nail so the scanner can detect the change in the LED's. However, with the typical resisting pet, it is difficult to keep the paw steady for a sufficient amount of time. It is similarly problematic that the pet's nail has to be positioned precisely in the clipper. Another problem is that the sensor has to be “on”, meaning that the handles have to be kept partially squeezed while the nail is inserted. This, too, is awkward when trying to control a squirming pet.

Many users also report that the technology is ineffective; that the sensor detects the quick too quickly or too late. This merely gives a false sense of security. It is also often observed that the clipper does not cut cleanly through the nail, and may crush or split the nail. In addition, it may not be sturdy enough, causing the cutting blade to twist away from the portion of the blade that the nail fits through.

As such, considering the foregoing, it may be appreciated that there continues to be a need for novel and improved devices and methods for cutting the nails of a pet.

### SUMMARY OF THE INVENTION

The foregoing needs are met, to a great extent, by the present invention, wherein in aspects of this invention, enhancements are provided to the existing model of nail clippers for pets.

In aspects of this invention, a safety nail clipper for pets can include unique safety features, comprising:
a. a funnel, which helps guide the pet's nail to a cutting-style nail clipper, placed near the inside end of the funnel, or immediately adjacent to the end of the funnel, which is met by
b. a safety stop behind the cutting-style clipper. This safety stop ensures that it is not possible to cut off more of the pet's nail than the equivalent of the distance between the cutting-style clipper and the safety stop behind the cutting-style clipper.

In aspects of this invention, the safety nail clipper for pets uniquely solves the problems associated with current nail clipper devices because:
a. It is a cutting-style nail clipper, which means it is quick acting, but in contrast to the current cutting-style nail clippers, there is no area or hole in which the nail can mistakenly end up.
b. It includes a funnel, which ensures that the pet's nail is quickly and safely guided towards the cutter, so that there is nowhere else for it to go, and the nail is held still and steady at the desired place.
c. It includes a safety stop behind the cutter, to ensure that it is impossible to cut off more of the nail, than permitted by a safe distance between the cutter and the safety stop.
d. The cutting-style technology is lower-cost to manufacture and maintain, than Dremel and Quickfinder type clippers.
e. It emits no vibration or noise that can aggravate a pet.

These factors combine to make the safety nail clipper for pets a simultaneously quick, effective, convenient, cost-effective, no-vibration, no-noise, painless and uniquely safe solution for pet owners, groomers and vets to cut pets' nails.

Pet owners, and groomers and other professionals can benefit from using the safety nail clipper for pets to cut or trim their pets' nails or claws because they can rest assured that the safety nail clipper for pets will
a. help regulate the length and evenness of their pets' nails or claws;
b. operate quickly, effectively, conveniently, cost-effectively, without any vibration or noise, painlessly and safely.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a safety nail clipper for pets, according to an embodiment of the invention.

FIG. 2 is a side view of a safety nail clipper for pets, according to an embodiment of the invention.

FIG. 3 is a side view of a safety nail clipper for pets, illustrating a pet nail inside a funnel of the safety nail clipper for pets, according to an embodiment of the invention.

FIG. 4 is a bottom view of a safety nail clipper for pets, according to an alternative embodiment of the invention.

FIG. 5 is a top view of a traditional cutting-style nail clipper for pets.

FIG. 6 is a top view of a traditional cutting-style nail clipper for pets with an attached funnel, according to an embodiment of the invention.

FIG. 7 is a side view of a traditional cutting-style nail clipper for pets with an attached funnel and a safety stop, according to an embodiment of the invention.

FIG. 8 is a cross-sectional side view of a safety nail clipper for pets, illustrating a pet nail inside a funnel of the safety nail clipper for pets, according to an embodiment of the invention.

FIG. 9 is a cross-sectional side view of a safety nail clipper for pets, illustrating a pet nail inside a funnel of the safety nail clipper for pets, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Throughout this disclosure, a cutting-style nail clipper shall be understood to mean existing guillotine-style clippers, scissor- or plier-style clippers, opposing-blade clippers with a compound lever, and other type of clippers with a cutting element that includes at least one blade, which is designed to cut the nails of a pet with a swift cutting action.

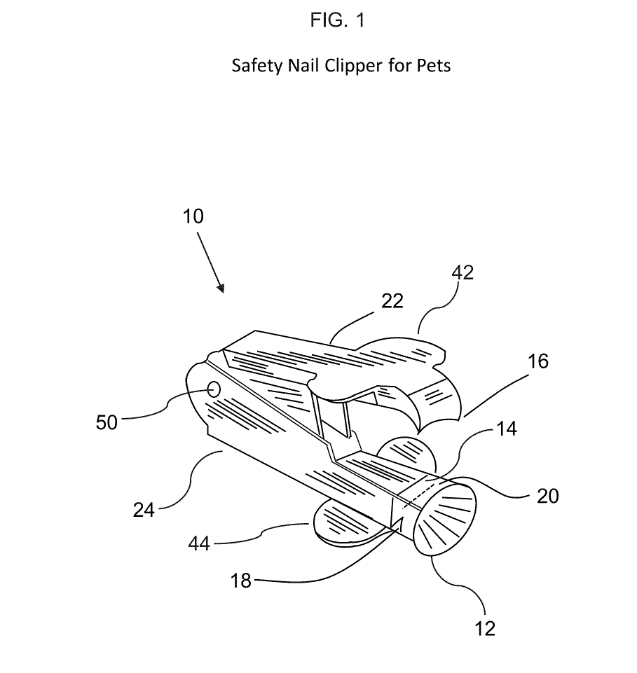

In the following, we describe the structure of an embodiment of a safety nail clipper for pets 10 with reference to FIG. 1, in such manner that like reference numerals refer to like components throughout; a convention that we shall employ for the remainder of this specification.

In an embodiment, a safety nail clipper for pets 10, can comprise:
a. A top piece 22,
b. A top blade 16, which is connected to, or a part of the front end of the top piece 22,
c. A bottom piece 24,
d. A bottom blade, 18 which is connected to, or a part of the front end of the bottom piece 24;
e. A funnel 12, which is positioned such that a front aperture of the funnel 12 is in front of the cutting location 20, which is the cutting line formed when the top piece 22 and the bottom piece 24 are pressed together, so that the top blade 16 and the bottom blade 18 are in contact, along a line constituting the cutting location 20; and
f. A safety stop 14, which is located behind the cutting location 20;

Whereby
(1) a pet nail 26 can be led into and through the funnel 12, such that the shape of the funnel 12 helps guide the pet nail 26 to the safety stop 14, that forms a wall preventing further entry, so that the tip 28 of the pet nail 26 comes to an automatic stop, simultaneously leaving the quick of the nail 30 at a natural stop before reaching the cutting location 20, and subsequently;
(2) when the top blade 16 and bottom blade 18 are pressed together they meet at the cutting location 20, and in this process cut through the pet nail 26 between the tip of the pet nail 28 and the quick of the nail 30, leaving the quick of the nail 30 untouched and safe, such that the safety stop 14 ensures that it is not possible to cut off more of the pet's nail 24 than the equivalent of the distance between from where the top blade 16 and bottom blade 18 come together at the cutting location 20 to the safety stop 14, which acts as a wall preventing further entry, behind the cutting-style clipping action.

In related embodiments, the top piece 22, and the top blade 16 can be of identical shape, construction and size as the bottom piece 24, and the bottom blade 18, whereby the safety nail clipper 10 is top-bottom symmetrical, or substantially symmetrical, so that the top piece 22, and the top blade 16, can be referred to as respectively the first piece, and the first blade, and the bottom piece 24, and the bottom blade 18, can be referred to as the second piece, and the second blade.

In related embodiments, the combination of the safety stop 14 and the position of the cutting location 20 means that it is impossible to cut off more of a pet's nail 24 than the equivalent of the distance between the safety stop 14 and the position of the cutting location 20. This very significantly reduces or eliminates the risk of cutting off too much of a nail, thereby cutting into the quick of the nail, causing pain, bleeding and possible infection.

In a related embodiment, the top piece 22 and the bottom piece 24 can be pivotally connected via a connection point 50, which can be a connection pin, or some other common fastening mechanism allowing pivotal rotation of the top piece 22 relative to the bottom piece 24. The connection pin can be located in the back ends of the top piece 22 and the bottom piece 24, opposite to the respective locations of the top blade 16 and the bottom blade 18.

In related embodiments, the combination of the funnel 12 and the cutting-style clipper as constituted by the top blade 16 and bottom blade 18 coming together, also means that the safety nail clipper for pets 10 can be uniquely quick acting. The funnel 12 allows for a pet's nail 24 to be quickly and seamlessly guided to the quick-acting cutting-style clipping action, which significantly reduces the stress caused to the pet, and which makes the safety nail clipper for pets 10 far easier and more efficient to use on the pet.

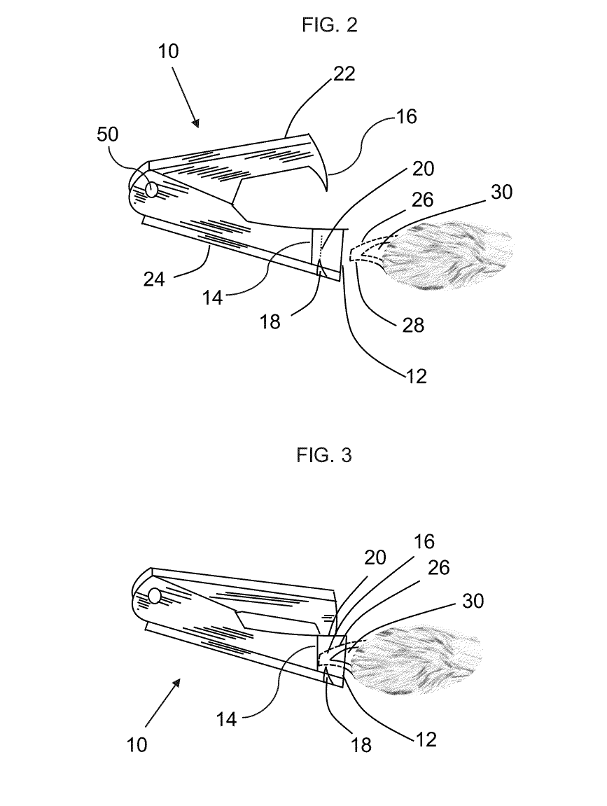

In a related embodiment, FIG. 2 illustrates a side view of the safety nail clipper for pets 10 showing the funnel 12, the wall that constitutes the safety stop 14, the top blade 16 and the bottom blade 18 that come together at the cutting location 20 just behind, and adjacent to or in close proximity the funnel 12 when the top piece 22 and the bottom piece 24 are pressed together. The pet nail 26 with tip 28 and quick 30 is shown at the entrance of the funnel 12, ready to be led into and through the funnel 12 and towards the safety stop 14.

In a related embodiment, FIG. 3 illustrates a side view of the safety nail clipper for pets 10 where the pet nail 26 has been led into and through the funnel 12, the shape of which has helped guide the pet nail 26 to the wall that constitutes the safety stop 14 where the tip of the pet nail 28 has come to an automatic stop, simultaneously leaving the quick of the nail 30 at a natural stop in front of the cutting location 20. The top blade 16 and bottom blade 18 have been pressed together so they meet at the cutting location 20 just behind, and adjacent to or in close proximity to the funnel 12, and in this process have cut through the pet nail 26 between the tip of the pet nail 28 and the quick of the nail 30, leaving the quick of the nail 30 untouched and safe.

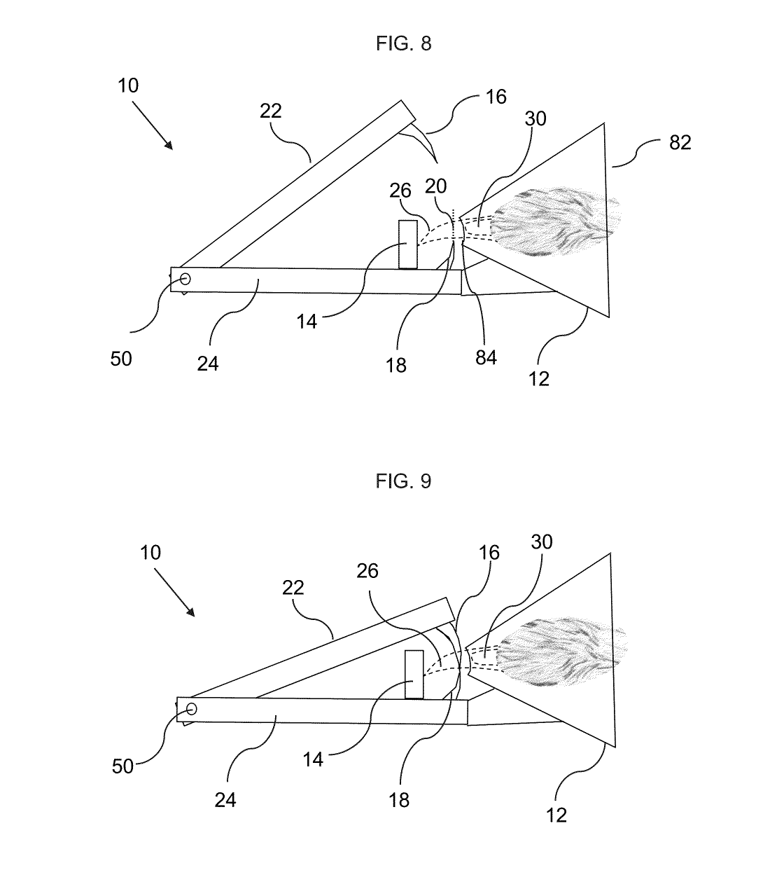

In a related embodiment, FIG. 8 illustrates a cross-sectional side-view, of a safety nail clipper for pets 10, showing the top and bottom pieces 22 24 in an open position, the top and bottom blades 16 18, the connection point 50, the safety stop 14, the funnel 12, with a nail 26, showing the inside quick 30, such that the nail 26 is inserted through the funnel 12, and has reached the safety stop 14, whereby it is in a position ready to be cut.

FIG. 8 illustrates an embodiment, wherein the funnel 12 is mounted entirely in front of the cutting location 20, such that a rear aperture 84 of the funnel 20 is in front of and in close proximity to the cutting location 20. Normally a close proximity distance between the rear funnel aperture 84 and the cutting location 20 can be predetermined within a range from 1 mm to 5 mm, but this can vary according to the particular application.

Furthermore, FIG. 8 illustrates an embodiment wherein the front funnel aperture 82 is wider than the rear funnel aperture 84, in order to guide the nail of a pet to the cutting location.

FIG. 9 illustrates the embodiment shown in FIG. 8, in a state where the top and bottom pieces 22 24 are in a closed position, and the nail 26 has been cut, without injury to the quick 30.

In related embodiments, the safety nail cutter for pets 10 can be manufactured from materials well known by persons of ordinary skill in the art to be suitable for standard nail-cutters, such as stainless steel, aluminum, and various types of plastic. The top and bottom blades 16 18, can be made from various hardened and sharpened materials including alloys of stainless steel, and suitable ceramic materials.

In related embodiments, the distance between the safety stop 14 and the cutting location 20 can be predetermined such that the safety nail clipper for pets 10 is designed for pets of a particular species and size. Normally the distance between the safety stop 14 and the cutting location 20 can be predetermined within a range from 1 mm to 15 mm, but this can vary according to the particular application.

In a further related embodiment, the position of the safety stop 14 can be adjusted, whereby the distance between the safety stop 14 and the cutting location 20 can be adjustable, allowing for use with different sizes and types of pet nails.

In related embodiments, the funnel 12 can be made with an alternative shape such as oval, elliptical, rectangular or triangular, or other shapes.

In a related embodiment, the funnel 12 can have a shape that does not gradually narrow.

In a related embodiment, the funnel 12 can be detachable from and re-attachable to the main body or basic frame of the safety nail clipper for pets 10, allowing different sizes and/or lengths of funnels 12 to accommodate different types of pets such as dogs, cats, rabbits, etc. and their different sizes and lengths of nails and claws.

In related embodiments, the funnel 12, can be
a. mounted entirely in front of the cutting location 20,
b. Or, alternatively, mounted so that a part of the funnel 12 continues after the cutting location 20 until reaching the safety stop 14, in which case the funnel may have top and/or bottom apertures to allow respectively the top and bottom cutting blades 16 18 to reach the cutting location 20. Optionally, one of the cutting blades 16 18 can be mounted inside the funnel 20.

In a related embodiment, the funnel 12 can be made of a transparent material, such as a transparent plastic, whereby the funnel 12 can allow for see-through operation.

In related embodiments, the top blade 16 and/or the bottom blade 18 can be manufactured with a plurality of alternative matching curvatures or shapes, including a straight design of both the top blade 16 and the bottom blade 18.

In a related embodiment, the safety nail clipper 10 can further comprise a wing-style top grip 42 and a similar wing-style bottom grip 44, whereby a user can press the on the grips, for example with a thumb on the top grip 42 and a corresponding hand index finger on the bottom grip 44.

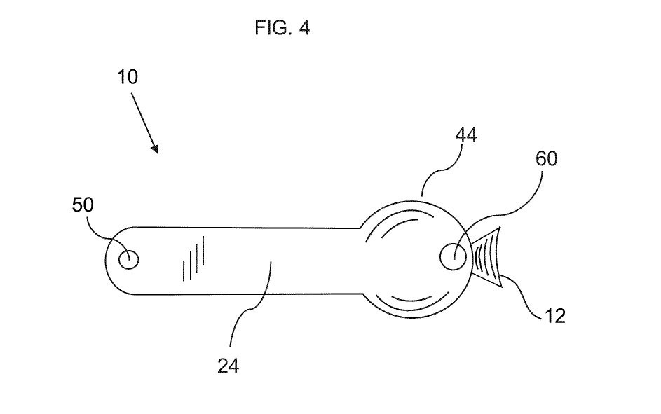

In related embodiments, the top piece 22 and/or bottom piece 24 can be made with a plurality of alternative shapes. In a further related example embodiment, FIG. 4 illustrates a bottom view of one such alternative shape, wherein the wing-style top and bottom grips 42 44 on the top piece 22 and bottom piece 24 of the safety nail clipper for pets 10 is replaced by circular style grips.

In a related embodiment, illustrated in FIG. 4, the safety nail clipper 10 can have an ejection hole 60, or opening, in a location between the cutting location 20 and the safety stop 14 that accommodates gravity induced falling out and emptying of nail cuttings. In various further related embodiments, depending on configuration, the ejection hole 60 can be in the bottom piece 24, in the funnel 12, or in another part of the safety nail clipper 10.

In a further related embodiment, a container or box can be placed below the ejection hole 60, to collect nail cuttings. The container can be configured in a position inside the safety nail clipper 10, or can be externally mounted.

In related embodiments, the safety nail clipper for pets 10 can be used on the nails or claws of wild animals.

In a related embodiment, the safety nail clipper for pets 10 can be used to trim the beaks of birds.

In a related embodiment, the funnel 12 itself and the principles underlying the functionality and benefit of the funnel 12, i.e. the quick and seamless guiding of the pet's nail 26 towards the cutting action and the steady positioning of it at the safety stop 14 and cutting location 20, can be applied to and work in conjunction with any other existing types and styles of nail clippers and nail trimmers. In this relation, such existing types of nail clippers and nail trimmers, can be characterized as comprised of:
a. a cutting implement, which is designed to cut the nail, and can be designed as a scissor- or plier-style, guillotine-style, or other common cutting mechanism used for nail clippers and nail trimmers. The cutting implement can be manually operated or operated by an in-built electric motor; and
b. a main body, to which the cutting implement is attached. The main body can be further comprised of scissor handles, or other components to hold and operate the existing nail clipper or trimmer.

In a further related embodiment, a safety nail clipper 10 can comprise a funnel 12, a safety stop 14, and a cutting implement, with a main body that includes a compound lever, which serves to gain a mechanical advantage in operation of the cutting implement, similar to compound levers used in existing nail clippers.

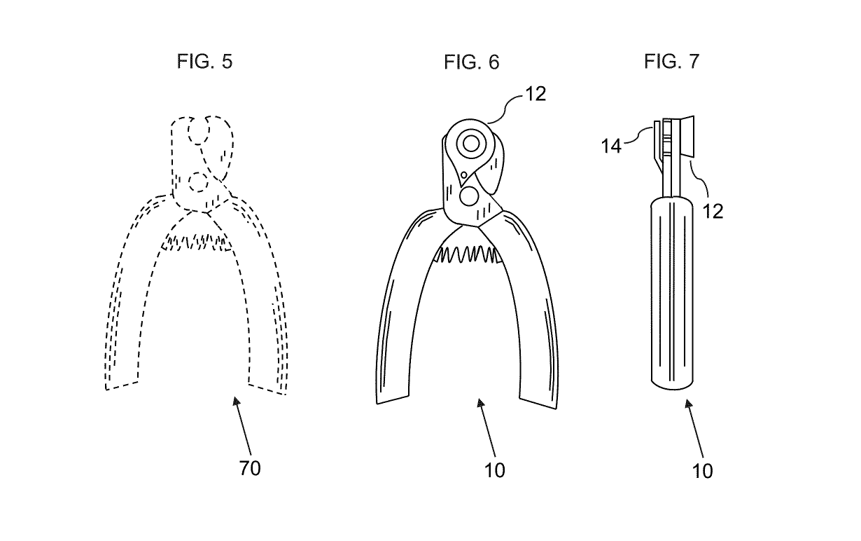

In another further related embodiment, FIG. 5, FIG. 6, and FIG. 7 are views of one such alternative application of the funnel principle; FIG. 5 illustrates a top view of a traditional cutting-style clipper 70, further comprised of a cutting implement. FIG. 6 shows a top view of an embodiment of the safety nail clipper for pets 10, with the entrance of the funnel 12 attached to and working in conjunction with the traditional cutting-style clipper 70. FIG. 7 illustrates a side view of a related embodiment of the safety nail clipper for pets 10, with the funnel 12 that is attached to and working in conjunction with the traditional cutting-style clipper 70, and a safety stop 14.

In a related embodiment, the constituents of the safety nail clipper for pets 10 can take an alternative shape, format or form.

In a related embodiment, different materials, sizes and interconnections can be used for all components.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A safety nail clipper for safe and fast cutting of the nails of a pet or wild animal, comprising:
a) a first piece;
b) a first blade, which is connected to the front of the first piece;
c) a second piece, wherein the first piece is connected to the second piece;
d) a second blade, which is connected to the front of the second piece;
e) a funnel, which is positioned such that a front aperture of the funnel is in front of a cutting location, wherein the cutting location is formed when the first piece and the second piece are pressed together, so that the top blade and the bottom blade are in contact, along a line constituting the cutting location;
whereby a pet nail can be led into and through the funnel, such that the shape of the funnel guides the pet nail to the cutting location, whereby further when the first blade and the second blade are pressed together they meet at the cutting location, and can thereby cut through the pet nail, between the tip of the pet nail, and the quick of the nail, leaving the quick of the nail untouched and safe.

2. The safety nail clipper of claim 1, further comprising:
f) a safety stop, which is positioned behind the cutting location;
whereby a pet nail can be led into and through the funnel, such that the shape of the funnel guides the pet nail to the safety stop, that forms a wall preventing further entry, so that a tip of the pet nail comes to an automatic stop, simultaneously leaving a quick of the nail at a natural stop before reaching the cutting location; and
whereby further when the first blade and the second blade are pressed together they meet at the cutting location, and can thereby cut through the pet nail between the tip of the pet nail and the quick of the nail, leaving the quick of the nail untouched and safe, such that the safety stop ensures that it is not possible to cut off more of the pet's nail than the equivalent of the distance between from where the first blade and the second blade come together, at the cutting location, to the safety stop.

3. The safety nail clipper of claim 1, wherein the first piece and the second piece are pivotally attached at a connection point, which forms a rotation center.

4. The safety nail clipper of claim 2, wherein a position of the safety stop can be adjusted, whereby the distance between the safety stop and the cutting location can be adjusted, allowing for use with different sizes and types of pet nails.

5. The safety nail clipper of claim 1, wherein the funnel is entirely in front of the cutting location, such that a rear aperture of the funnel is in front of and in close proximity to the cutting location.

6. The safety nail clipper of claim 1, wherein the funnel is configured with a narrowing shape, such that the front funnel aperture is wider than a rear funnel aperture.

7. The safety nail clipper of claim 1, wherein the funnel is a straight cylinder.

8. The safety nail clipper of claim 1, wherein the funnel is made of a transparent material.

9. The safety nail clipper of claim 2, further comprising an ejection hole located between the cutting location and the safety stop, whereby the ejection hole accommodates gravity induced falling out and emptying of nail cuttings.

10. The safety nail clipper of claim 1, wherein the first piece further comprises a first grip, and the second piece further comprises a second grip.

11. A safety nail clipper for safe and fast cutting of a nail of a pet or wild animal, comprising:
a) a nail clipper body;
b) a cutting implement, wherein the cutting implement is connected to the nail clipper body, and is configured to cut the nail at a pre-determined cutting location in the front of the nail clipper body, wherein further the nail can be cut as a result of a cutting motion of the cutting implement;
c) a funnel, which is positioned such that a front aperture of the funnel is in front of the cutting location;
whereby the nail can be led into and through the funnel, such that the shape of the funnel is configured to guide the nail to the cutting location, whereby further during cutting motion of the cutting implement, the nail can be cut between the tip of the pet nail, and the quick of the nail, leaving the quick of the nail untouched and safe.

12. The safety nail clipper of claim 11, further comprising:
d) a safety stop, which is positioned behind the cutting location;
whereby the nail can be led into and through the funnel, such that the shape of the funnel guides the nail to the safety stop, that forms a wall preventing further entry, so that a tip of the nail comes to an automatic stop, simultaneously leaving a quick of the nail at a natural stop before reaching the cutting location; and
whereby further when the first blade and the second blade are pressed together they meet at the cutting location, and can thereby cut through the pet nail between the tip of the pet nail and the quick of the nail, leaving the quick of the nail untouched and safe, such that the safety stop ensures that it is not possible to cut off more of the pet's nail than the equivalent of the distance between from where the first blade and the second blade come together, at the cutting location, to the safety stop, which acts as a wall preventing further entry.

13. The safety nail clipper of claim 11, wherein the cutting implement further comprises a first piece connected with a first blade, and a second piece connected with a second blade, wherein the first piece and the second piece are pivotally attached at a connection point, which forms a rotation center.

14. The safety nail clipper of claim 12, wherein a position of the safety stop can be adjusted, whereby the distance between the safety stop and the cutting location can be adjusted, allowing for use with different sizes and types of pet nails.

15. The safety nail clipper of claim 11, wherein the funnel is entirely in front of the cutting location, such that a rear aperture of the funnel is in front of and in close proximity to the cutting location.

16. The safety nail clipper of claim 11, wherein the funnel is configured with a narrowing shape, such that a front funnel aperture is wider than a rear funnel aperture.

17. The safety nail clipper of claim 11, wherein the funnel is a straight cylinder.

18. The safety nail clipper of claim 11, wherein the funnel is made of a transparent material.

19. The safety nail clipper of claim 12, further comprising an ejection hole located between the cutting location and the safety stop, whereby the ejection hole accommodates gravity induced falling out and emptying of nail cuttings.

20. The safety nail clipper of claim 13, wherein the first piece further comprises a first grip and the second piece further comprises a second grip.
